(19) United States
(12) Patent Application Publication
(10) Pub. No.: US 2010/0050101 A1
(43) Pub. Date: Feb. 25, 2010

(54) Converting Information Objects

(75) Inventors: Myong Jay Baik, San Francisco, CA (US); Justin Yoshiji Kodama, East Palo Alto, CA (US)

Correspondence Address: RAUBVOGEL LAW OFFICE, 820 LAKEVIEW WAY, REDWOOD CITY, CA, 94062, US

(73) Assignee: PALM, INC., Sunnyvale, CA (US)

(21) Appl. No.: 12/195,886

(22) Filed: Aug. 21, 2008

(51) Int. Cl. G06F 17/30; G06F 3/048

(52) U.S. Cl. 715/764; 707/103 R; 707/E17.055

(57) ABSTRACT

A system and method perform automated, intelligent conversion of an information object from one type to another. An original information object is parsed to ascertain the nature of individual data items within the object. Relevant data items are extracted and a new object is populated intelligently based on the extracted data. Pattern matching, user input, defined fields, or any combination thereof can be used to identify the data to be extracted from the original object.

### CROSS-REFERENCE TO RELATED APPLICATION

The present application is related to U.S. patent application Ser. No. 09/772,449 filed Jan. 29, 2001 for “METHOD AND APPARATUS FOR SINGLE-STEP USER GENERATED NOTES ON A PERSONAL DIGITAL ASSISTANT”, the disclosure of which is incorporated herein.

### FIELD OF THE INVENTION

In various embodiments, the present invention relates to information-bearing objects in a software application, and more particularly to methods and systems for converting such objects from one type to another.

### DESCRIPTION OF THE RELATED ART

Users increasingly use electronic devices to store, access, and manage information such as contacts, appointments, tasks, notes, reminders, and the like. It is particularly useful to be able to manage such information on a portable device such as a smartphone, personal digital assistant (PDA), handheld computer, or the like, although users also use desktop and laptop computers when such devices are available. Software applications are available and well-known for managing such information on desktop or laptop computers, and for synchronizing the information with portable devices. For ease of nomenclature, such software is collectively referred to herein as contact management software, although it will be recognized that such software often manages many types of information in addition to contacts. Specifically, contact management software typically integrates several types of information, such as calendar appointments, contacts, email, tasks, notes, journal entries, and the like. One well-known example of such software is Microsoft Outlook 2007, available from Microsoft Corporation of Redmond, Wash.

Users of contact management software can add new information objects by selecting the type of object to be added (such as a new contact or appointment), and entering relevant information in various fields in order to describe the new object. For example, for a new appointment, a user might enter a description, location, date, time, reminder, and the like. For a new contact, a user might enter a name, address, telephone number, email address, and the like. Other types of information objects are less structured, such as notes, which may provide a single free-form text entry field into which the user can enter any text he or wishes to store for later use.

Users of contact management software can also receive text messages or email messages bearing new information objects. For example, a user may receive an email message including an invitation to a meeting. By clicking on Accept, the meeting is added to the user's calendar; in effect, a new information object representing the meeting is created and stored.

One limitation of existing contact management software is that it is often difficult to convert an information object from one type to another. For example, if a user wishes to convert a memo to a contact, he or she must generally create a new contact and enter (or cut and paste) the relevant information from the memo into the various fields associated with a contact. Such a process may be laborious and time-consuming.

This limitation is particularly significant for mobile devices, where users may capture information on-the-fly, without regard to what type of object should be created. For example, a user may quickly open a new memo on a PDA in order to capture an email address or telephone number, without first creating a new contact first. Subsequently, the user may want to convert the memo into a contact, but the process of doing so is inconvenient, particularly on a PDA. The user may decide to wait until the memo is “synched” to the user's desktop computer, where cutting and pasting to a new contact record may be less burdensome. However, the user may forget to convert the object later, or it may not synch properly because it is a memo and not a contact. Also, the user may have difficultly finding the correct memo containing the contact information.

Finally, even if the user does remember to perform the conversion and is able to locate the correct memo, the process of converting is often a multi-step procedure that fails to automatically capture the relevant information and populate the appropriate fields correctly. Often, information for each field must be separately copied and pasted from the old object to the new object. This is particularly difficult on mobile devices where it may not be possible or feasible to run multiple windows containing the old object and the new object.

As another example, a user may receive a text message containing information for an event such as a dinner reservation. The user may wish to convert the text message into an event object. However, on existing software the conversion may be difficult or time-consuming.

Some software, such as Microsoft Outlook, performs rudimentary object conversion in response to drag-and-drop operations. For example, if a user drags an email message onto a calendar area, a new calendar appointment is created, containing the subject and text of the original email message. However, no additional information is extracted from the email message. Thus, if the email message contains text describing a date, time, and location for the meeting, the user must still manually enter (or cut and paste) those items into the calendar appointment. Furthermore, such drag-and-drop operations may be cumbersome on a mobile device with limited screen space, as it may not be feasible to display an object while also displaying potential target locations onto which the object may be dropped. Furthermore, there is no provision for automatic conversion in response to detecting that an object contains information that indicates it is a candidate for conversion to another object type.

In addition, in existing software there is no clear indication as to which objects can be converted and how they can be converted. Because the conversion of objects is a feature that is often difficult to discover and difficult to use properly, many users do not use the feature; therefore, they do not take advantage of the potential benefits of such a feature.

What is needed, therefore, is a method and system for easy conversion of information objects from one type to another that alleviates the disadvantages and limitations of prior art systems. What is further needed is a method and system that allows a user to convert an object from one type to another in an automated and streamlined way, whether the operation is performed on a mobile device or on a desktop computer or other device. What is further needed is a method and system that reliably extracts information from an object in order to correctly convert the object to another type with minimal burden on the user. What is further needed is a system that can automatically recognize a likely event type based on the content of an information object.

### SUMMARY OF THE INVENTION

In various embodiments, the present invention provides automated, intelligent conversion of an information object from one type to another.

In one embodiment, the invention provides object-level “smart” cut-and-paste (or copy-and-paste) that parses an existing information object to ascertain the nature of individual information items within the object, extracts relevant information items as needed for a new information object, and populates the new information object intelligently based on the extracted information.

Thus, for example, in converting a text message to a contact, embodiments of the present invention parse the text message to identify relevant information items for a contact, such as name, telephone number, email address, and the like. These items are extracted from the text message, and fields for a new contact are populated with the extracted information. The result is a new contact containing the relevant information from the text message, generated with minimal burden on the user.

In one embodiment, the user can verify the new information object and can edit it as desired before it is saved. In another embodiment, the new information object is saved without presenting the user with an opportunity to edit it, but the user is able to edit it afterwards.

In one embodiment, object conversion takes place in response to explicit user commands. For example, the user may select one or more objects and initiate a “convert” command; the user may specify the destination object type, or the system of the present invention according to various embodiments can infer the destination object type from the content of the object.

In another embodiment, object conversion takes place automatically responsive to detection of an object containing content that is suited to a particular type that is different from the object's current type.

In one embodiment, when object conversion takes place, the original object is deleted. In other embodiments, the original object is left untouched, or the user is given a choice as to whether or not the original object is to be deleted.

In another embodiment, the user can select a part of the original object to be converted to a new type. For example, the user can select some text within a note and initiate a “convert” command. The selected text is then converted to an object type, either specified by the user or automatically determined.

Additional features and advantages will become apparent in the description provided below.

### BRIEF DESCRIPTION OF THE DRAWINGS

The accompanying drawings illustrate several embodiments of the invention and, together with the description, serve to explain the principles of the invention according to various embodiments. One skilled in the art will recognize that the particular embodiments illustrated in the drawings are merely exemplary, and are not intended to limit the scope of the present invention.

FIG. 1A depicts an example of conversion of an email message to a calendar appointment, according to one embodiment.

FIG. 1B depicts an example of a pull-down menu that can be used to resolve ambiguity during conversion, according to one embodiment.

FIG. 2 is a flow diagram depicting a method for practicing the present invention according to one embodiment, wherein a user initiates a conversion.

FIG. 3 is a flow diagram depicting a method for practicing the present invention according to one embodiment, wherein conversion takes place automatically.

FIGS. 4A to 4E depict screen shots for an example of conversion of an email message to a task, according to one embodiment.

FIG. 5 depicts an example of an architecture for practicing the present invention according to one embodiment.

### DETAILED DESCRIPTION OF THE EMBODIMENTS

### System Architecture

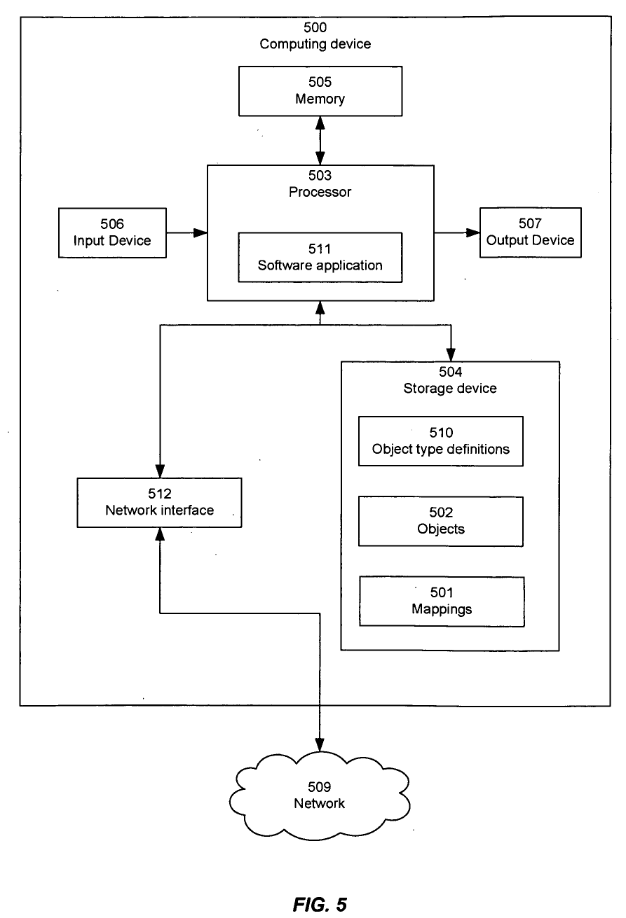

Referring now to FIG. 5, there is shown an example of an architecture for practicing the present invention according to one embodiment. Computing device 500 includes various components that are used in practicing the invention according to one embodiment. In various embodiments, the present invention can be implemented on any electronic device, such as a smartphone, cellular telephone, handheld computer, personal digital assistant (PDA), personal computer, kiosk, and the like. For example, in various embodiments, the invention can be implemented as a feature of a software application for performing functions including email management, contact management, calendaring, note-keeping, and task management functions. In various embodiments, the invention can be embodied in the application itself or as a feature of an operating system.

In various embodiments, the invention is particularly well-suited to devices such as smartphones, handheld computers, and PDAs, which have limited screen space and which are often used for calendaring, managing email, and similar functions. One skilled in the art will recognize, however, that in other embodiments the invention can be practiced in many other contexts, including any environment in which it is useful to convert objects from one type to another. Accordingly, the following description is intended to illustrate embodiments of the invention by way of example, rather than to limit the scope of the claimed invention.

In one embodiment, computing device 500 includes processor 503 that runs software application 511. Software application 511 can include instructions for performing the steps associated with embodiments of the present invention. Alternatively, these instructions can be provided as part of an operating system, plug-in, or other software component.

Computing device 500 includes input device 506, such as a keyboard, touch-screen, proximity-sensitive screen, touchpad, mouse, trackball, roller switch, 5-way switch, or the like, or any combination thereof. Computing device 500 also includes output device 507, such as a display screen.

Storage device 504 may be a hard drive, flash memory, or any other known means for storing data electronically. As is known in the art, data from storage device 504 can be transferred to memory 505, manipulated by processor 503, and saved back to storage device 504. In one embodiment, objects 502 are stored in storage device 504, along with object type definitions 510 that specify various characteristics of object types, and mappings 501 that specify relationships among data items in various object types. Such mappings 501 can take the form of a table, database, or any other storage paradigm.

In one embodiment, network interface 512 is provided, to allow for wired and/or wireless communication via network 509, which may be the Internet, WAN, LAN, wireless network, or the like. Such communication can take place over any known protocol and mechanism, including for example, TCP/IP, Wi-Fi, BlueTooth, Ethernet, or the like.

In various embodiments, the present invention can also be implemented in a web-based environment, where individual objects are stored at a server and manipulated by a user via a remote client via a web browser. Such web-based applications are well known, for example, in implementing web-based email, contact management, and calendaring functionality.

One skilled in the art will recognize that many other architectures are possible, and that additional components may be present or absent without departing from the essential characteristics of the present invention as set forth in the claims. Furthermore, the particular allocation of functionality among the various components shown in FIG. 5 can be varied without departing from the essential characteristics of the present invention.

### Object Conversion

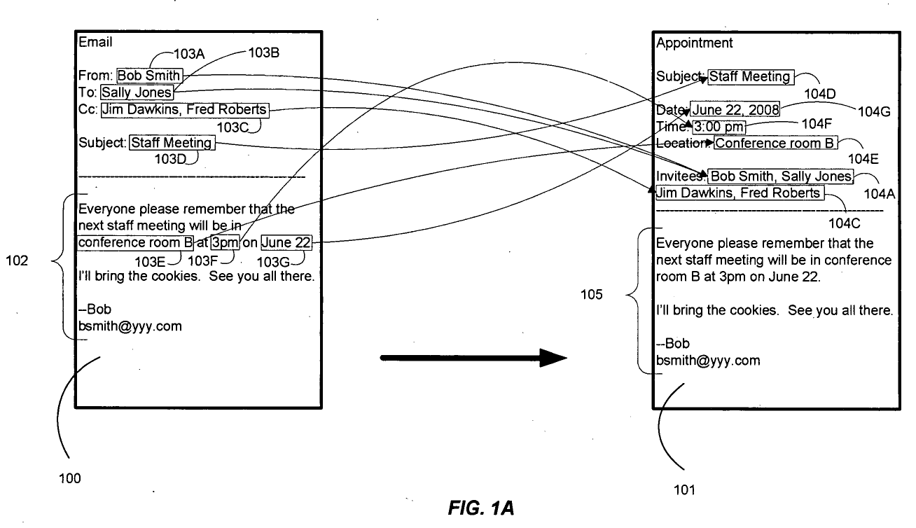

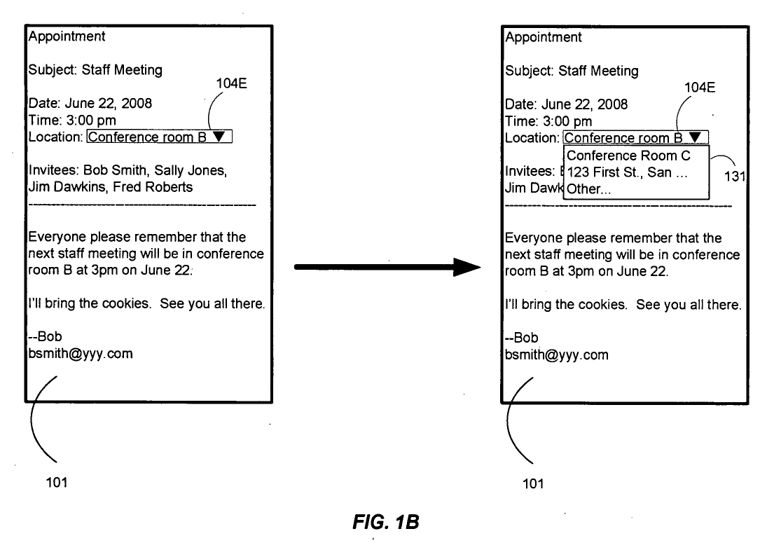

Referring now to FIG. 1A, there is shown an example of conversion of an original object (email message 100) to a destination object (calendar appointment 101), according to one embodiment. Message 100 and appointment 101 are objects of different types in the context of various embodiments of the present invention. According to the techniques described herein, embodiments of the system of the present invention create a new calendar appointment object 101, and parse email message 100 to identify data items 103A through 103G that are relevant to calendar appointment 101. The relevant data items are extracted from email message 100, and calendar appointment 101 is populated with the data items. For example, as shown in FIG. 1A, the system of the invention in one embodiment may extract the following data items for a calendar appointment 101, when such items are identified within the original object such as email message 100:
Email sender 103A, used to populate invitee field 104A;
Email recipient 103B, used to populate invitee field 104A;
Email cc recipient 103C, used to populate invitee field 104C;
Subject 103D, used to populate subject field 104D;
Location 103E, used to populate location field 104E;
Time of meeting 103F, used to populate time field 104F;
Date of meeting 103G, used to populate date field 104G.

In addition, text 102 of email message 100 can be imported into a notes area 105 of calendar appointment 101.

One skilled in the art will recognize that the example of FIG. 1A is merely illustrative, and that many other data items and arrangements can be used without departing from the essential characteristics of the invention.

In one embodiment, at least a subset of the data items are identified by their placement within defined fields with the original object. For example, in FIG. 1A, email sender 103A, recipient 103B, cc recipient 103C, and subject 103D are easily identified because they are found within defined fields. In one embodiment, the system of the present invention maintains mappings 501 among defined fields for various object types, so that it can easily transfer relevant information from an original object to a destination object. In this example, the mapping 501 would indicate that senders and recipients for an email message should be included as attendees for a calendar appointment.

Other data items may be identified by parsing text fields. For example, once the system has determined that email message 100 is to be converted to a calendar appointment 101, it can parse text 102 of email message 100 in an attempt to identify additional information relevant to a calendar appointment. Natural language processing can be used for this operation, as well as consultation with relevant tables to look for likely relevant information. For example, in FIG. 1A, the phrase “conference room B” 103E is identified as referring to a location, and is used to populate location field 104E. In one embodiment, a list of commonly used meeting locations may be maintained (for example, including names of conference rooms), so that the system of the present invention can properly identify a data item that likely contains a meeting location.

If ambiguity exists (for example if two phrases appear to refer to possible meeting locations), the user can be given an opportunity to select among the identified candidates, or to override the populated field by entering the correct information. Referring now to FIG. 1B, there is shown an arrangement where field 104E can be opened into a pull-down menu 131 that can be used to resolve ambiguity during conversion, according to one embodiment. Pull-down menu 131 can be presented at or proximate to location field 104E. When opened, menu 131 shows the candidate locations that were extracted from text 102. In one embodiment, the most likely choice is presented at the top of the menu as a default. The user can thereby select the correct item. In one embodiment, the user can type over the menu 131, or select an “other . . . ” menu item, to enter a different location.

Dates and times, telephone numbers, email addresses, and other information can be identified within text 102 by known pattern matching techniques. For example, “(NNN) NNN-NNNN” or “NNN-NNN-NNNN” can be recognized as telephone numbers, or “aaa@bbb.ccc” can be recognized as an email address. Patterns of the form “MM/DD/YY” or “YYYY/MM/DD” (among many other formats) can be recognized as dates. Days of the week and months of the year can also be recognized. Times of day, expressed for example as “N:NN pm/am” or “NN:NN”, can also be recognized. Such techniques are well known in the art.

Again, if ambiguity exists, multiple options can be presented to the user, and the user can select or override as needed.

As described in more detail below, in one embodiment, the user is given an opportunity to review and edit the newly created object (calendar appointment 101) before it is finalized or saved. If required data is missing because it could not be identified in the original object, the user may be prompted to enter the required data before the object can be saved.

### Method of Operation

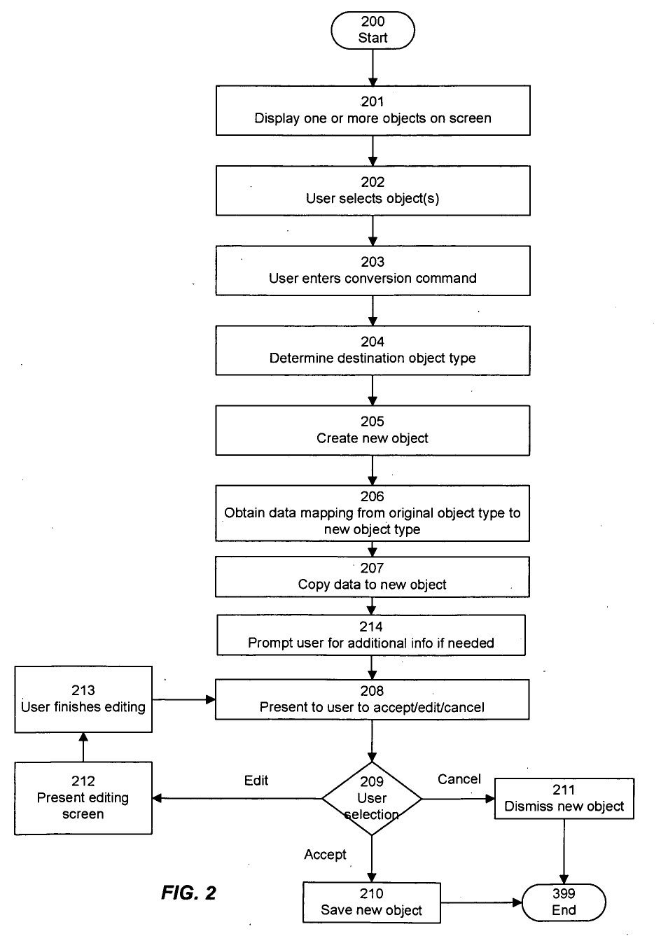

Referring now to FIG. 2, there is shown a flow diagram depicting a method for practicing the present invention according to one embodiment. In the method shown in FIG. 2, the conversion to a new object type takes place in response to a user command. For example, the user may indicate that he or she wishes to convert a task to a calendar appointment, or an email message to a contact, or the like. The original object can be one that the user has generated, either contemporaneously or in the past, or it can be an object that the user received from another individual, such as for example an email or text message.

An object or list of objects is displayed 201 on a screen. Techniques for displaying these types of objects in the context of a contact management or email program are well known in the art. For example, a calendar may be displayed containing appointments, or an email inbox may be displayed containing email messages, or a task list may be displayed containing tasks.

The user selects 202 one or more of the displayed objects, for example by tapping on them or causing a cursor to move to particular objects and then initiating a selection command. Other selection methodologies are well known in the art.

The user then initiates a conversion operation, for example by entering 203 a command. This can be done, for example, by selecting a command from a pull-down or pop-up menu, or by tapping on an on-screen button, or by entering a keyboard command, gesture, or other form of input. The conversion may also be initiated when a user performs a copy-and-paste operation from a list of objects of one type to a list of objects of another type, or when a user drags an object to an area associated with another object type (for example, by dragging an email message onto a calendar).

In the embodiment of FIG. 2, the conversion is performed responsive to the user entering the conversion command. As will be seen in other embodiments, the conversion can be performed in response to other events as well.

The destination object type is determined 204. This is the type of object that is to be generated by the conversion operation. In one embodiment, the user can specify the destination object type, for example by selecting from a pull-down or pop-up menu. Alternatively, various onscreen buttons can be provided for initiating conversion to various types of objects (for example, “Convert to appointment”, “Convert to task”, and the like). Other input mechanisms can also be used.

Alternatively, the system of the present invention can in one embodiment automatically determine a destination object type, based on various factors. In one embodiment, the destination object type can be determined based on the content of the original object. For example, a text message containing a meeting location, a time, and a date can reasonably be inferred to be descriptive of a calendar appointment; therefore the destination object type can be automatically determined to be a calendar appointment. In embodiments where the destination object type is automatically determined, the user can be given an opportunity to override the automatic determination and to select a different destination object type. Alternatively, the automatically determined object type can be presented as a default which can be changed by the user. In another embodiment, the determined object type can be assumed to be correct, without verification or approval by the user. A degree of confidence in the automatic determination can be ascertained in order to decide whether to prompt the user for verification.

A new object is created 205, of the type determined in step 204. A mapping 501 is obtained 206, specifying which fields of the original object type map to which fields of the new object type. For example, in converting from an email message to a calendar appointment, a mapping might be present between the sender (and recipients) of the email message and the meeting attendees. In one embodiment, these mappings 501 are stored in storage device 504 and retrieved when needed. In one embodiment, if a mapping 501 is not available, a user can be prompted to indicate which fields in the original object map to which fields in the new object; the user input can then be stored as a new mapping 501 and made available for future conversions to/from the same object types. Alternatively, in one embodiment, if a mapping 501 is not available, the user can be prompted to type in any relevant information for the new object.

As described above, mappings 501 can include data extracted from text fields by natural language processing and/or pattern matching. These mappings 501 can also be refined over time based on user feedback approving or rejecting proposed mappings 501.

Data items are then copied 207 from the original object to the new object, based on the obtained mapping 206. In one embodiment, this step is performed by populating fields of the new object with extracted data from the original object. Where appropriate, the data may be reformatted or otherwise modified to suit the fields of the new object. For example, extracted text specifying “3 pm” may be reformatted to “3:00 pm” or even “15:00”; the particular reformatting operations may depend on user preferences and settings, geographic locale, language considerations, software requirements, maximum field lengths and formatting considerations, and the like.

If any additional information is needed, the user can optionally be prompted 214 to enter additional information. The appropriate fields of the new object are populated with the entered information.

In one embodiment, the new object including populated fields is presented 208 to the user. The user can accept, edit, or cancel 209 the conversion operation. In one embodiment, the user indicates his or her preference by tapping on an on-screen button, or by entering a keyboard command, or by some other input mechanism. In one embodiment, if the user does not respond within some period of time, a default response is assumed (such as Cancel).

If the user accepts the conversion operation, the new object is saved 210, for example in storage device 504. In one embodiment, the original object is retained as well, unless the user indicates that it should be deleted. In another embodiment, the original object is deleted. In yet another embodiment, the original object is flagged to indicate that it has been converted, so as to avoid repeatedly converting the same object.

If the user indicates that he or she wishes to edit the new object, an editing interface is presented 212, whereby the user can edit the various fields of the new object. In one embodiment, some fields may not be editable (for example, date of creation of the object); in other embodiments, all fields may be editable. Once the user finishes editing 213, the method returns to step 208.

If the user wishes to cancel the conversion operation, the new object is dismissed 211 without being saved, or is deleted if it was provisionally saved.

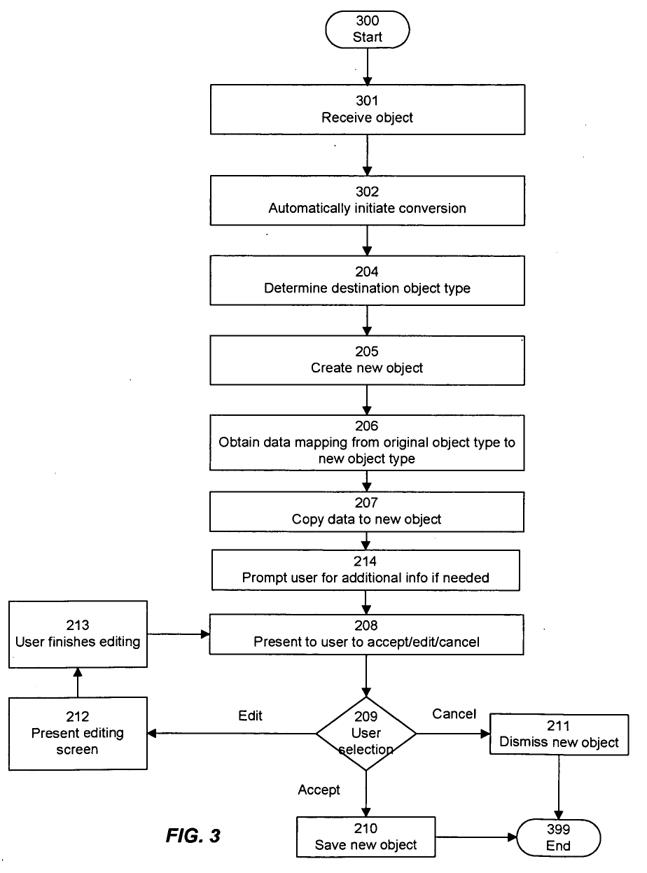

Referring now to FIG. 3, there is shown a flow diagram depicting a method for practicing the present invention according to another embodiment. In the method shown in FIG. 3, the conversion to a new object type takes place automatically, for example in response to receipt or retrieval of an object having characteristics indicating that it should be converted to another type. For example, if an email message is received that specifies a date, time, and location, these particular characteristics of the message indicate that the email message contains information representing an appointment; accordingly, conversion to an appointment might be automatically initiated.

An object is received 301. This may include, for example, receiving a communication containing or embodying the object (such as an email message). Alternatively, it may include the user creating, retrieving or opening an object having certain characteristics that warrant conversion.

Based on a trigger event such as the detection of an object that warrants conversion, conversion is automatically initiated 302. In one embodiment, the system of the present invention suggests conversion of an object by prompting the user (for example, by displaying a “Convert this object?” dialog box), but does not proceed with the conversion unless the user indicates assent to the suggestion. In another embodiment, the system of the present invention proceeds with conversion automatically without awaiting the user's assent.

The remaining steps of the method of FIG. 3, steps 204 through 213, are identical to those discussed above in connection with FIG. 2.

### EXAMPLE

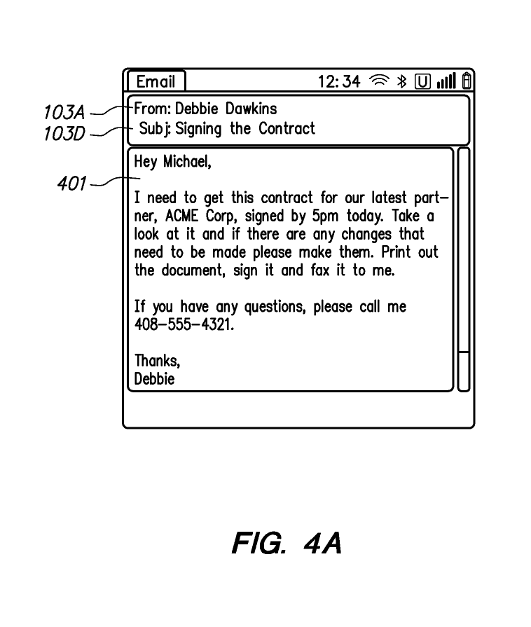

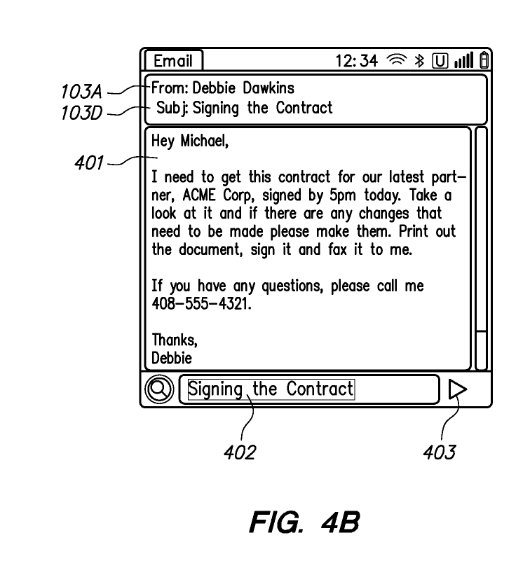

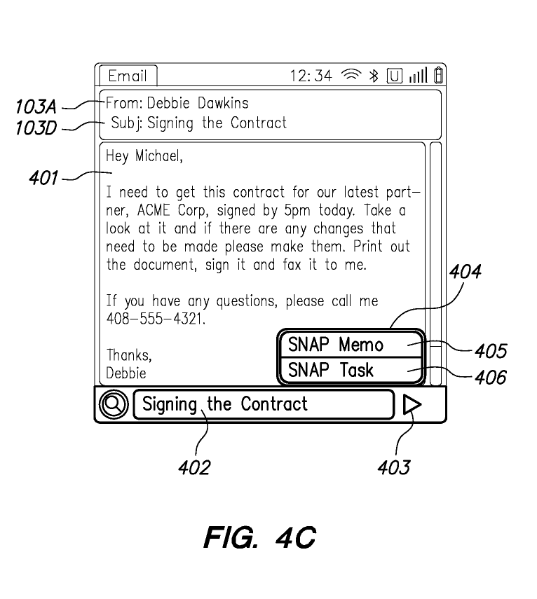

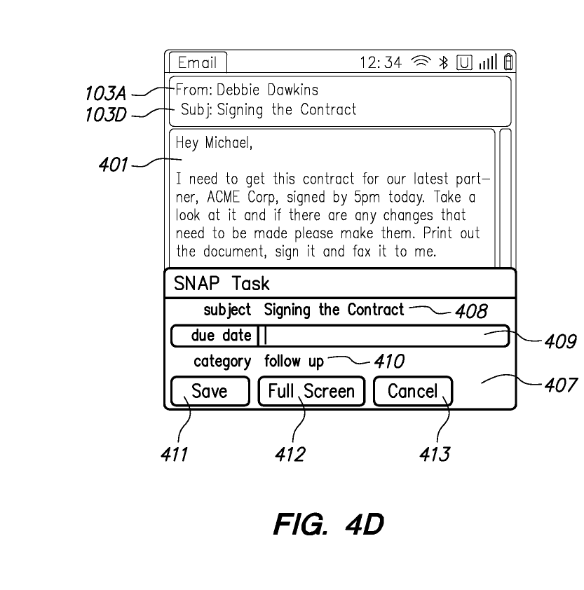

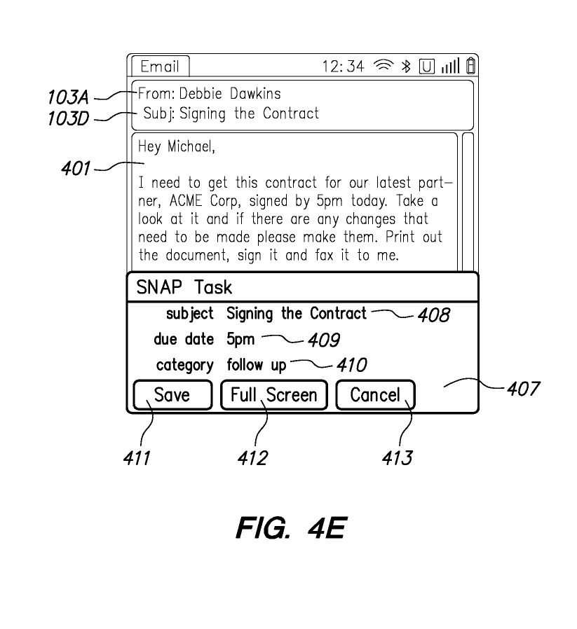

Referring now to FIGS. 4A through 4E, there is shown a set of screen shots for an example of conversion of an email message to a task, according to one embodiment.

FIG. 4A depicts email message 401 in its initial state, as it might be shown on output device 507 such as a display screen. As is typical of a display of an email message, sender 103A, subject 103D, and message text 102 are shown. The user can manipulate email message 401 by well known mechanisms, including deleting, replying, saving, categorizing, and the like.

In FIG. 4B, the user is given an opportunity to initiate a conversion to another object type. Field 402 appears, including a proposed title for the new object. In the embodiment depicted in this example, the system of the present invention identifies the subject 103D of the email message 401 as being mapped to the title of the new object. Field 402 is editable, so that the user can change or override the suggested text.

Button 403 provides access to the conversion feature. In the example of FIG. 4B, button 403 is shown as an arrow. However, it can take any form, such as a button, menu item, or the like.

In FIG. 4C, the user has tapped on button 403, causing pop-up menu 404 to appear. Menu 404 includes possible destination object types for the conversion operation. In the example of FIG. 4C, the candidate object types are memo and task; therefore menu options 405, 406 indicate these two object types. In FIG. 4D, the user has selected the task option 406. Dialog box 407 is presented, showing that subject field 408 has been populated according to the stored mapping, by inserting text from email subject 103D into field 408. A category field 410 defaults to “follow up”, which has been defined as a default value. In one embodiment, the default is predetermined based on user preferences; in another embodiment it is based on natural language processing performed on text 102 of the email message 401. A due date field 410 appears as well, prompting the user to enter a due date because that data item could not be gleaned from the original email message 401.

The user can click on Save button 411 to save the task as a new object. As mentioned above, the original email can be retained or deleted when the conversion operation is finalized.

The user can click on Full Screen button 412 to enter a mode wherein the task can be edited in more detail. Cancel button 413 causes the conversion operation to be cancelled.

In FIG. 4E, the user has filled in due date field 410. Again, the user can click on Save 411, Full Screen 412, or Cancel 413.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference herein to “one embodiment”, “an embodiment” , or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for converting an object from an original object type to a destination object type, comprising:
identifying an original object to be converted, the original object being of an initial object type;
determining a destination object type for the original object;
creating a new object of the destination object type;
retrieving a mapping specifying relationships between data items of the original object type and data items of the destination object type;
extracting data items from the original object;
responsive to the mapping, copying the extracted data items to the new object;
storing the new object.

2. The method of claim 1, wherein each object type comprises one selected from the group consisting of:
email messages;
tasks;
calendar appointments;
memos;
notes;
text messages; and
contacts.

3. The method of claim 1, wherein identifying an original object to be converted comprises receiving a user command to convert at least one object.

4. The method of claim 1, wherein identifying an original object to be converted comprises receiving a user command to drag and drop at least one object to a location associated with a destination object type.

5. The method of claim 1, wherein identifying an original object to be converted comprises automatically detecting at least one original object having data corresponding to an object type other than the object type of the original object.

6. The method of claim 1, wherein determining a destination object type comprises receiving user input specifying a destination object type.

7. The method of claim 1, wherein determining a destination object type comprises automatically determining a destination object type responsive to content of the original object.

8. The method of claim 1, wherein determining a destination object type comprises:
automatically determining at least one possible destination object type responsive to content of the original object;
presenting the at least one possible destination object type to a user; and
receiving user input selecting a destination object type.

9. The method of claim 1, wherein retrieving a mapping comprises:
prompting a user to specify a relationship between at least one data item of the original object type and at least one data item of the destination object type; and
receiving user input specifying the relationship.

10. The method of claim 1, further comprising, prior to storing the new object:
displaying the new object;
prompting the user to enter input indicating whether to accept, delete, or edit the new object;
and wherein storing the new object comprises:
responsive to user input to accept the new object, storing the new object;
responsive to user input to delete the new object, deleting the new object; and
responsive to user input to edit the new object:
accepting user input to edit the new object;
editing the new object according to the user input; and
storing the edited object.

11. The method of claim 1, wherein extracting data items from the original object comprises retrieving data from at least one defined field in the original object.

12. The method of claim 1, wherein extracting data items from the original object comprises:
identifying at least one data item in a text field of the original object;
receiving user input indicating whether the identification of the at least one data item is correct; and
responsive to the received user input indicating that the identification of the at least one data item is correct, extracting the at least one identified data item.

13. The method of claim 1, wherein copying the extracted data items to the new object comprises, for each extracted data item:
identifying a data field in the new object to receive the extracted data item; and
writing the extracted data item to the identified data field.

14. The method of claim 1, further comprising deleting the original object.

15. The method of claim 1, further comprising flagging the original object as having been converted.

16. A computer program product for converting an object from an original object type to a destination object type, comprising:
a computer-readable storage medium; and
computer program code, encoded on the medium, for:
identifying an original object to be converted, the original object being of an initial object type;
determining a destination object type for the original object;
creating a new object of the destination object type;
retrieving a mapping specifying relationships between data items of the original object type and data items of the destination object type;
extracting data items from the original object;
responsive to the mapping, copying the extracted data items to the new object;
storing the new object.

17. The computer program product of claim 16, wherein each object type comprises one selected from the group consisting of:
email messages;
tasks;
calendar appointments;
memos;
notes;
text messages; and
contacts.

18. The computer program product of claim 16, wherein the computer program code for identifying an original object to be converted comprises computer program code for receiving a user command to convert at least one object.

19. The computer program product of claim 16, wherein the computer program code for identifying an original object to be converted comprises computer program code for receiving a user command to drag and drop at least one object to a location associated with a destination object type.

20. The computer program product of claim 16, wherein the computer program code for determining a destination object type comprises computer program code for:
automatically determining at least one possible destination object type responsive to content of the original object;
presenting the at least one possible destination object type to a user; and
receiving user input selecting a destination object type.

21. A system for converting an object from an original object type to a destination object type, comprising:
a storage device, for storing mappings specifying relationships among data items in various object types;
a display device, for displaying at least one object to be converted; and
a processor, for:
identifying an original object to be converted, the original object being of an initial object type;
determining a destination object type for the original object;
creating a new object of the destination object type;
retrieving, from the storage device, a mapping specifying relationships between data items of the original object type and data items of the destination object type;
extracting data items from the original object; and
responsive to the mapping, copying the extracted data items to the new object;
wherein:
the display device displays the new object; and
the storage device stores the new object.

22. The system of claim 21, wherein each object type comprises one selected from the group consisting of:
email messages;
tasks;
calendar appointments;
memos;
notes;
text messages; and
contacts.

23. The system of claim 21, further comprising a user input device, for receiving a user command to convert at least one object.

24. The system of claim 21, further comprising a user input device, for receiving a user command to drag and drop at least one object to a location associated with a destination object type.

25. The system of claim 21, further comprising:
a user input device, for receiving user input;
and wherein the processor determines a destination object type by:
automatically determining at least one possible destination object type responsive to content of the original object;
causing the display device to present the at least one possible destination object type to a user; and
receiving a signal from the user input device representing user input selecting a destination object type.
